(19) United States
(12) Patent Application Publication
(10) Pub. No.: US 2024/0402581 A1
(43) Pub. Date: Dec. 5, 2024

(54) CAMERA MODULE CARRYING DEVICE

(71) Applicant: Rayprus Technology (Foshan) Co., Ltd., Foshan (CN)

(72) Inventor: PO-HSIANG HUANG, New Taipei (TW)

(21) Appl. No.: 18/241,490

(22) Filed: Sep. 1, 2023

(30) Foreign Application Priority Data
May 30, 2023 (CN) 202321346819.4

(51) Int. Cl. G03B 17/56

(52) U.S. Cl. CPC G03B 17/563

(57) ABSTRACT

Disclosed in the present invention is a camera module carrying device. The camera module carrying device includes a housing, and the includes a main body portion, the main body portion defines at least two accommodating slots and at least two opening, each accommodating slots is connected to each opening, each accommodating slot is configured to accommodate a camera module, and the opening is configured to buckle a signal transmission portion of the camera module. Users can control the camera modules on the camera module carrying device through the electronic device to achieve different detection functions.

### FIELD

The present disclosure relates to the technical field of camera technology, in particular to a camera module carrying device.

### BACKGROUND

Sensors can be applied to a camera module of an electronic device after combining sensing technology and imaging technology, so that the camera module of the electronic device has different detection functions. For example, a new generation of odor sensors is applied to the camera modules of the electronic device, to generate the images based on the odor of the object. The camera module may provide with a wireless communication module so that after the camera module is detached from the electronic device, the electronic device can still control the camera module through the wireless communication module. However, the number of the camera modules installed in the electronic device is limited, so it is inconvenient for users to use the camera modules with different detection functions.

Therefore, improvement is desired.

### BRIEF DESCRIPTION OF THE DRAWINGS

FIG. 1 is a scene diagram of a camera module carrying device according to an embodiment of the present disclosure.

FIG. 2 is a schematic diagram of a camera module according to an embodiment of the present disclosure.

FIG. 3 is a schematic diagram of the camera module carrying device according to an embodiment of the present disclosure.

FIG. 4 is another schematic diagram of the camera module carrying device according to an embodiment of the present disclosure.

FIG. 5 is a scene diagram of the camera module carrying device according to another embodiment of the present disclosure.

### DETAILED DESCRIPTION

It will be appreciated that for simplicity and clarity of illustration, where appropriate, reference numerals have been repeated among the different figures to indicate corresponding or analogous elements. Additionally, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. The drawings are not necessarily to scale and the proportions of certain parts may be exaggerated to better illustrate details and features. The description is not to be considered as limiting the scope of the embodiments described herein.

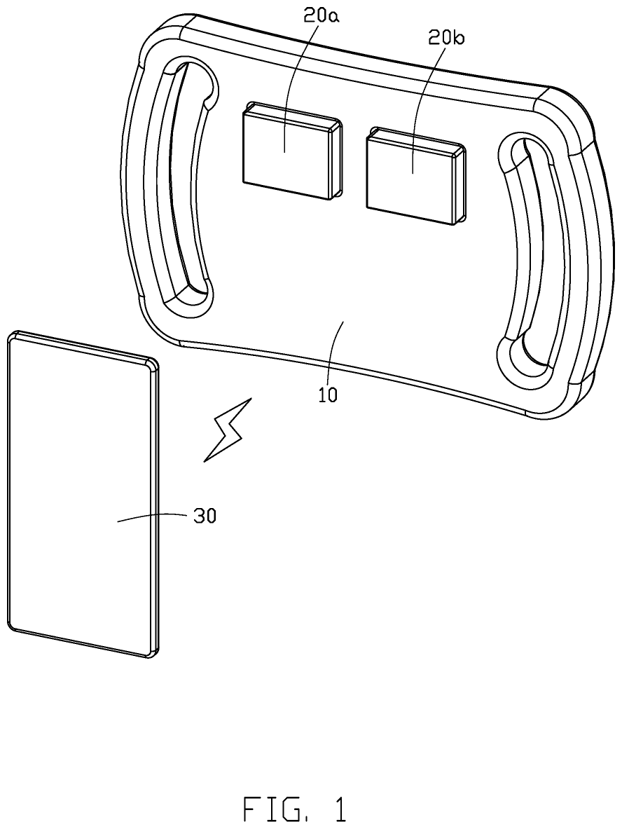

FIG. 1 illustrates a camera module carrying device 10 in accordance with an embodiment of the present disclosure.

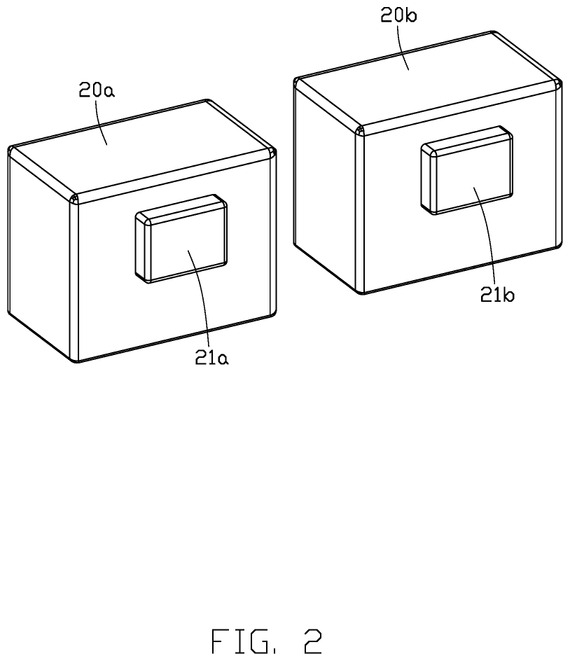

In the embodiment, the camera module carrying device 10 is used to accommodate a plurality of camera modules. FIG. 1 shows a camera module 20a and a camera module 20b as examples for illustration, the camera module 20a is provided with a temperature sensor and the camera module 20b is provided with a light sensor. The camera module includes a signal transmission portion, and the signal transmission portion is used for transmitting and receiving signals. As shown in FIG. 2, the camera module 20a includes a signal transmission portion 21a, and the camera module 20b includes a signal transmission portion 21b. In other embodiments, the number of the camera modules may also be more than two.

The camera module 20a and the camera module 20b is communicated with an electronic device 30. The electronic device 30 is installed with an application (APP). For example, a temperature detection application of the electronic device 30 may be used to control the camera module 20a, and a light detection application in the electronic device 30 may be used to control the camera module 20b. In some embodiments, the electronic device 30 may be a cell phone, a personal computer, or a smart watch.

For example, a user can hold the camera module carrying device 10 and aim it at a detection object. In response to the user's operation, the electronic device 30 first controls the camera module 20a to detect a degree of corruption of the fruit, and then controls the camera module 20b to detect what kind of fruit it is. The user can know through the electronic device 30 that a detection object is an apple, and the degree of corruption of the apple is fresh.

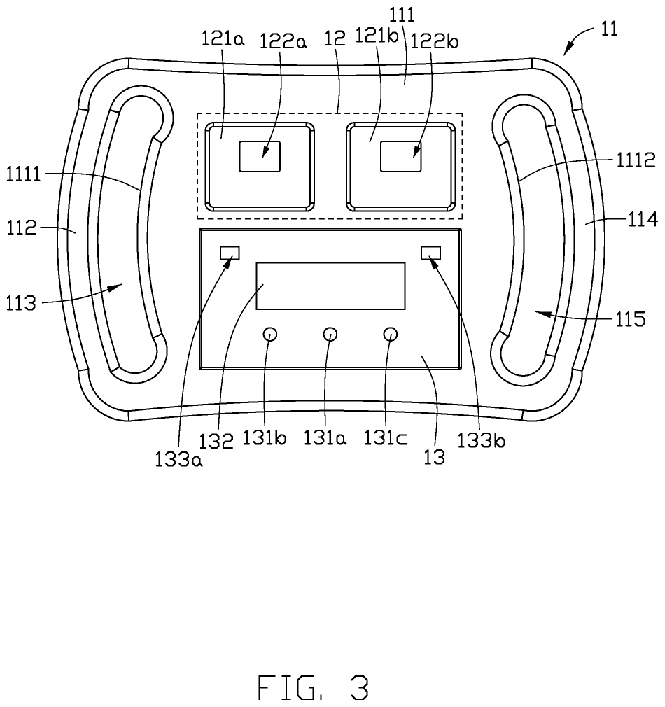

FIG. 3 is a schematic diagram of the camera module carrying device 10 in accordance with an embodiment of the present disclosure.

In the embodiment, the camera module carrying device 10 includes a housing 11, the housing 11 includes a main body portion 111 and a first handheld portion 112, the first handheld portion 112 is fixedly connected to a first end 1111 of the main body portion 111. For example, the first handheld portion 112 is disposed at an upper end, a lower end, a left end or a right end of the main body portion 111. The user holds the first handheld portion 112 to avoid blocking the camera module from receiving or sending signals.

The housing 11 further defines a first groove 113, the first groove 113 is located between the main body portion 111 and the first handheld portion 112, the hand of the user can pass through the first groove 113 to hold the first handheld portion 112. The first groove 113 has rounded shapes at both ends to match the shape of the fingers and to improve the comfort of the user when holding the first handheld portion 112.

The main body portion 111 further includes a mounting area 12, and the mounting area 12 of the housing 11 may be used to accommodate a plurality of the camera modules, for example, the mounting area 12 is used to accommodate the camera module 20a and the camera module 20b.

The mounting area 12 defines a plurality of accommodating slots, each accommodating slot accommodates one camera module, a shape of the accommodating slot matches a shape of the camera module, and a cross-sectional shape of the accommodating slot can be circular, oval, or square. The cross-sectional shape of the accommodating groove is not specifically limited. The accommodating slots can be disposed side by side on the main body portion 111. For example, the mounting area 12 may be provided with a first accommodating slot 121a and a second accommodating slot 121b, the first accommodating slot 121a and the second accommodating slot 121b are laterally distributed on the main body portion 111, and the first accommodating slot 121a is disposed on the left side of the second accommodating slot 121b. The accommodating slots may also be disposed side by side on the main body portion 111, for example, the first accommodating slot 121a and the second accommodating slot 121b are longitudinally distributed on the main body portion 111, and the first accommodating slot 121a is disposed on an upper side of the second accommodating slot 121b.

When the number of the accommodating slots in the mounting area 12 exceeds two, the plurality of the accommodating slots can be distributed on the main body portion 111 at equal intervals. For example, the distances between the first accommodating slot 121a, the second accommodating slot 121b, a third accommodating slot (not shown in figures) and a fourth accommodating slot (not shown in figures) are equal. The distances between the plurality of the accommodating slots may be adjusted according to actual needs, for example, the distance between the first accommodating slot 121a and the second accommodating slot 121b is greater than the distance between the third accommodating slot and the fourth accommodating slot.

The mounting area 12 defines a plurality of openings, the plurality of the accommodating slots corresponding to the plurality of the openings, and each accommodating is connected to the corresponding opening. For example, a first opening 122a is connected to the first accommodating slot 121a, and a second opening 122b is connected to the second accommodating slot 121b. When the camera module 20a is accommodated in the first accommodating slot 121a, the signal transmission portion 21a of the camera module 20a can be clipped into the first opening 122a, so that the camera module 20a can receive or send the signals through the first opening 122a. When the camera module 20b is accommodated in the second accommodating slot 121b, the signal transmission portion 21b of the camera module 20b can be clipped into the second opening 122b, so that the camera module 20b can receive or send the signals through the second opening 122b. The shape of each opening matches the shape of the signal transmission portion appropriately, and the cross-sectional shape of the opening can be circular, rectangular, elliptical, or square, without any limitations on the shape of the opening. The slot wall of the accommodating slot is provided with a damping portion (not shown in figures) to increase the friction between the camera module and the camera module carrying device 10.

Each camera module has an accommodating space, which reduces the impact of the replacement action on other camera modules when replacing a particular camera module.

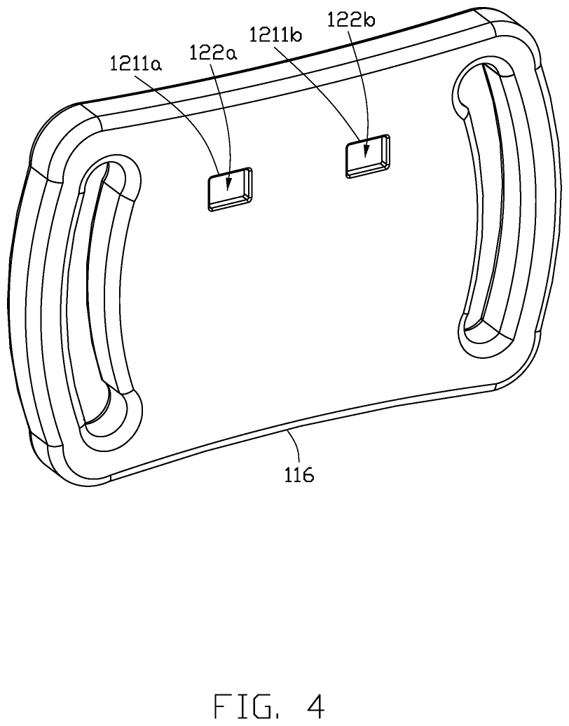

As shown in FIG. 4, in one embodiment, the distances from the openings to an end 116 of the housing 11 may be the same or different. For example, the first opening 122a has an end 1211a away from the end 116 of the housing 11, and the second opening 122b has an end 1211b away from the end 116 of the housing 11. The distance from the end 1211a of the first opening 122a to the end 116 of the housing 11 and the distance from the end 1211b of the second opening 122b to the end 116 of the housing 11 is the same, so that the signal transmission portion 21a protruding from the first opening 122a and the signal transmission portion 21b protruding from the second opening 122b detect the detection object at the same height. In another embodiment, the distance from the end 1211a of the first opening 122a to the end 116 of the housing 11 and the distance from the end 1211b of the second opening 122b to the end 116 of the housing 11 is not the same, so that the signal transmission portion 21a protruding from the first opening 122a and the signal transmission portion 21b protruding from the second opening 122b detect the detection object at different heights. It can be understood that the present disclosure may adjust the position of the openings according to the different detection functions implemented by the electronic device 30.

The present disclosure can accommodate the plurality of the camera modules simultaneously by defining a plurality of the accommodating slots in the housing 11, and the opening of the accommodating slots can be engaged with the signal transmission portion of the camera modules, it is convenient for users to carry different camera modules.

As shown in FIG. 3, in some embodiments, a second end 1112 of the main body portion 111 includes a second handheld portion 114, the second handheld portion 114 is disposed opposite the first handheld portion 112. When the user holds the camera module carrying device 10 in one hand, the user can choose to hold the camera module carrying device 10 in the left hand or in the right hand, which is convenient for the users with different holding habits, it is also convenient for the user to hold the camera module carrying device 10 with both hands. Specifically, the second handheld portion 114 and the first handheld portion 112 are respectively disposed on opposite ends of the main body portion 111. For example, when the first handheld portion 112 is disposed on an upper end of the housing 11, the second handheld portion 114 is disposed at a lower end of the housing 11, and when the first handheld portion 112 is disposed on a left end of the housing 11, the second handheld portion 114 is disposed on a right end of the housing 11.

The housing 11 further defines a second groove 115, the second groove 115 is defined between the main body portion 111 and the second handheld portion 114. The hand of the user can pass through the second groove 115 to hold the second handheld portion 114. Two ends of the second groove 115 are arc-shaped to match the shape of the fingers, so as to improve the user's comfort when holding the second handheld portion 114.

In some embodiments, both the first handheld portion 112 and the second handheld portion 114 define a groove (not shown in figures), the groove matches the shape of a finger. The bottom wall of the groove is provided with a damping portion, so as to increase the frictional force of the user holding the camera module carrying device 10.

In some embodiments, the first handheld portion 112 and the second handheld portion 114 are detachably installed on the housing 11, and the first handheld portion 112 and the second handheld portion 114 may be integrally formed with the housing 11.

In some embodiments, the housing 11 is flat as a whole; when the cross-sectional shape of the housing 11 is square, the four corners of the edge of the housing 11 are arc shaped. The edge of one end of the housing 11 is recessed downwards at both ends, the opposite edges of the one end are recessed upwards at both ends, so that the two ends of the housing 11 are recessed toward the middle, which is convenient for the user to hold the camera module carrying device 10 through the recessed portion in the middle. The cross-sectional shape of the housing 11 is not specifically limited. The material of the housing 11 can be plastic or metal. The size of the housing 11 can be designed according to the size of the camera module 20. For example, if the length of the camera module 20 is 5 cm, the width of the camera module 20 is 4 cm, and the height of the camera module 20 is 2 cm, the length of the housing 11 is 25 cm, the width of the housing 11 is 18 cm, and the height of the housing 11 is 2.5 cm. The size of the housing 11 is not specifically limited. The present disclosure makes the camera module carrying device 10 easy to carry by designing the structure and the size of the housing 11, the housing 11 defines an accommodating space, and the accommodating space can accommodate various modules of the camera module carrying device 10.

In some embodiments, the camera module carrying device 10 further includes a control panel 13 and a control module (not shown) electrically connected to the control panel 13. The control panel 13 is disposed on the main body portion 111. Specifically, the control panel 13 is disposed on a surface of the main body portion 111 away from the opening, so as to prevent the user from blocking the signal transmission portion protruding from the opening when operating the control panel 13. The shape of the control panel 13 can be circular, oval or square, and the shape of the control panel 13 is not limited.

The control panel 13 includes at least two buttons and a touch screen 132 for user operation. The number of the buttons can be multiple, and the function of each button can be customized. For example, a first button 131a is used to start the camera module 20a, a second button 131b is used to select the camera module 20a or the camera module 20b, and a third button 131c is used to stop the work of the camera module. The touch screen 132 generates different instructions in response to different gestures of the user, for example, the user clicks the touch screen 132, the camera module 20a and the camera module 20b are activated, the user long presses on the touch screen 132 and the camera module 20a and the camera module 20b are deactivated.

The control panel 13 includes at least two interfaces, the at least two interfaces are electrically connected to corresponding camera modules through the connectors. For example, the control panel 13 includes an interface 133a and an interface 133b, the interface 133a is connected to the camera module 20a through a first connector, and the interface 133b is connected to the camera module 20b through a second connector.

The control module is used to receive the instructions generated by the buttons and the touch screen 132, to control the camera modules to work together, and to analyze detection information of the camera modules to generate a detection result. The control module may be, but is not limited to, a microcontroller unit (MCU) or a central processing unit (CPU).

In some embodiments, the camera module carrying device 10 further includes a wireless communication module (not shown in figures) electrically connected to the control module. The wireless communication module is accommodated in the housing 11, the wireless communication module is used to establish a wireless communication connection with the camera module 20 and the electronic device 30. The wireless communication module may be, but is not limited to, a Bluetooth unit, a ZigBee Technology unit, an ultra-low-power wireless transmission unit, a wireless ultra-wide band (UWB) pulse unit, a near field communication (NFC) unit.

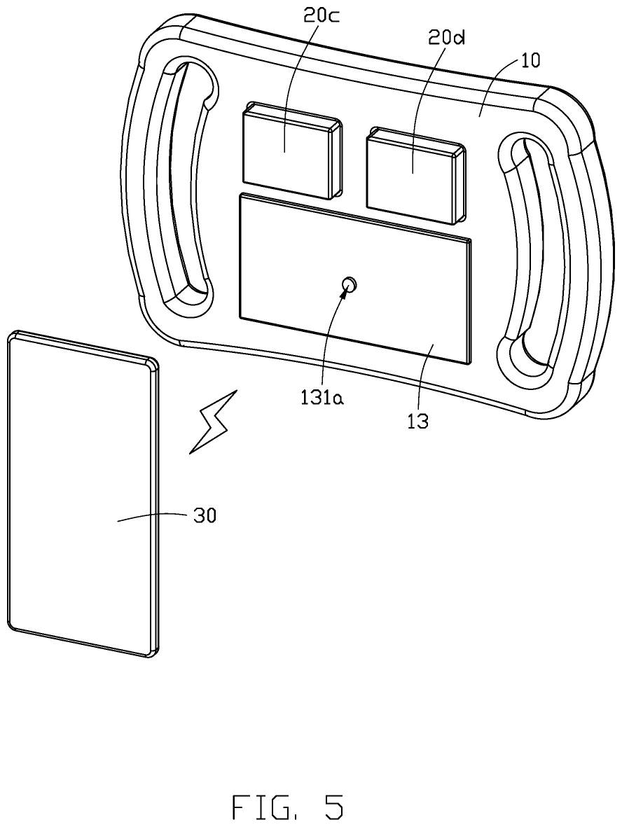

FIG. 5 shows scenario diagram of the camera module carrying device 10 in accordance with another embodiment of the present disclosure.

The camera module carrying device 10 accommodates a camera module 20c and a camera module 20d. The camera module 20c is provided with a video graphics array (VGA) sensor, and the camera module 20d is provided with a thermal sensor. The user holds the camera module carrying device 10 and aligns the detection object, the user clicks the button 131a of the control panel 13, the camera module 20c tracks and locates to a forehead of the person, and the camera module 20d detects the temperature of the forehead of the person. The control module generates an image and body temperature of the forehead based on position information and temperature information of the forehead, and sends the image and the body temperature of the forehead to the electronic device 30. The user can know the body temperature of the detection object through the electronic device 30.

The camera module carrying device 10 accommodates the camera modules, the user can control the camera module through the electronic device 30, or the user can control the camera module 20 through the control panel 13.

Those of ordinary skill in the art should realize that the above embodiments are only used to illustrate the present disclosure, but not to limit the present disclosure. As long as they are within the essential spirit of the present disclosure, the above embodiments are appropriately made and changes fall within the scope of protection of the present disclosure.

What is claimed is:

1. A camera module carrying device comprising:
a housing comprising a main body portion,
wherein the main body portion defines a plurality of accommodating slots and a plurality of openings, an accommodating slot is connected to an opening, the accommodating slot is configured to accommodate a camera module, and the opening is configured to buckle a signal transmission portion of the camera module.

2. The camera module carrying device of claim 1, wherein the housing further comprises a first handheld portion, the first handheld portion is connected to a first end of the main body portion, and a first groove is defined between the first handheld portion and the first end of the main body portion.

3. The camera module carrying device of claim 2, wherein the housing further comprises a second handheld portion, the second handheld portion is connected to a second end of the main body portion, the first handheld portion and the second handheld portion are respectively disposed at opposite ends of the main body portion, and a second groove is defined between the second handheld portion and the second end of the main body portion.

4. The camera module carrying device of claim 1, wherein the opening is in a rectangular shape.

5. The camera module carrying device of claim 1, wherein the at least two accommodating slots are disposed side by side on the main body portion.

6. The camera module carrying device of claim 1, further comprising a control panel, wherein the control panel is located on a surface of the main body portion away from the opening.

7. The camera module carrying device of claim 6, wherein the control panel comprises at least one interface, the control panel is electrically connected to the camera module through the at least one interface.

8. The camera module carrying device of claim 1, wherein the main body portion defines a mounting area, and the at least two accommodating slots are defined in the mounting area.

9. The camera module carrying device of claim 3, wherein the first handheld portion and the second handheld portion are detachably installed on the housing.

10. The camera module carrying device of claim 3, wherein the first handheld portion and the second handheld portion is integrally formed with the housing.

11. A camera module carrying device comprising:
a control panel; and
a housing comprising a main body portion,
wherein the main body portion defines a plurality of accommodating slots and a plurality of openings, an accommodating slot is connected to an opening, the accommodating slot is configured to accommodate a camera module, and the opening is configured to buckle a signal transmission portion of the camera module,
the main body portion defines a mounting area, and the accommodating slots are defined in the mounting area, and
the control panel is located on a surface of the main body portion away from the opening.

12. The camera module carrying device of claim 11, wherein the housing further comprises a first handheld portion, the first handheld portion is connected to a first end of the main body portion, and a first groove slot is defined between the first handheld portion and the first end of the main body portion.

13. The camera module carrying device of claim 12, wherein the housing further comprises a second handheld portion, the second handheld portion is connected to a second end of the main body portion, the first handheld portion and the second handheld portion are respectively disposed at opposite ends of the main body portion, and a second groove is defined between the second handheld portion and the second end of the main body portion.

14. The camera module carrying device of claim 11, wherein the opening is in a rectangular shape.

15. The camera module carrying device of claim 11, wherein the at least two accommodating slots are disposed side by side on the main body portion.

16. The camera module carrying device of claim 11, wherein the control panel comprises at least one interface, the control panel is electrically connected to the camera module through the at least one interface.

17. The camera module carrying device of claim 13, wherein the first handheld portion and the second handheld portion are detachably installed on the housing.

18. The camera module carrying device of claim 13, wherein the first handheld portion and the second handheld portion is integrally formed with the housing.
